(19) United States
(12) Patent Application Publication
(10) Pub. No.: US 2005/0147272 A1
(43) Pub. Date: Jul. 7, 2005

(54) Speaker suspension element

(75) Inventors: David E. Hyre, Seattle, WA (US); Daniel C. Wiggins, Edmonds, WA (US)

Correspondence Address: Robert A. Jensen;Jensen & Puntigam, P.S., 2033 6th Ave. #1020, Seattle, WA, 98121, US

(73) Assignee: Adire Audio, Seattle, WA (US)

(21) Appl. No.: 11/031,283

(22) Filed: Jan. 7, 2005

Related U.S. Application Data
(60) Provisional application No. 60/534,636, filed on Jan. 7, 2004.

(51) Int. Cl. H04R 1/00; H04R 9/06

(52) U.S. Cl. 381/398; 381/404

(57) ABSTRACT

A suspension element allowing motion along an axis including two or more radial, compliant suspension arms, each having a central portion deviating circumferentially and arranged such that the midportion of each arm can translate along at least one of the circumferential or radial directions during axial translation to distribute stress along and across the path. The suspension element is adapted for use in an electro-acoustical device.

### TECHNICAL FIELD

This application claims the priority of provisional patent application Ser. No. 60/534,636, filed Jan. 7, 2004 by David E. Hyre and Daniel C. Wiggins.

This invention relates to electromechanical transducers, especially to acoustical types, and more particularly, to an element responsible for supplying the forces to keep the transducer element centered. And more particularly, to a suspension element that is comprised of a metallic or conductive material to allow facile and interference-free transmission of current to a mobile coil-like element, and to increase linearity and amplitude of motion and reduce hysteresis and energy losses over existing methods.

### BACKGROUND OF THE INVENTION

It has long been the desire to produce an improved audio speaker, i.e., one that effectively and accurately reproduces the input waveform without distortion over a wide frequency range. In general, the typical acoustic speaker system includes a current-carrying conductor, most commonly a coil, that reacts to the flux of a permanent magnet in the motor by moving axially, accelerating in response to the amount of current in the coil, i.e. the Lorentz force B•I. In general, as the coil moves it drives a diaphragm, and this moving assembly is suspended by an element responsible for returning the moving parts to their rest position in the absence of applied energy. This motion creates the sound as a vibration in the air. The suspending element is typically responsible for centering the moving parts in both axial and radial directions, usually more strongly in the radial direction, to prevent interference with other parts while still allowing the axial motion conducive to sound reproduction.

Performance of the loudspeaker suspension significantly impacts the ability of a given unit to accurately reproduce the input signal. This is exacerbated at the lowest frequencies and loudest volumes, where large excursions become necessary to produce the sound. Indeed, the displaced volume required for a given acoustical level scales as the inverse square of the frequency (Vd∝1/f\hat{ }2), thus requiring a driver to excurse four times as much to reproduce a signal at the same sound pressure level (SPL) at half the frequency. Likewise, the required excursion scales linearly with output, so that increasing the output level twofold requires twice the excursion. Thus, playing low frequencies at significant SPL requires a suspension capable of large excursions. Ideally, for any driver, the performance of such a suspension would remain constant over the required excursion, and would do so to large displacements in units requiring large excursion. This has been difficult and expensive to achieve with the existing art, leading to undesirable distortions readily apparent in units employing the prior art.

Distortions in the reproduced waveform are created by a number of causes, of which variability and hysteresis in the spring constant and mechanical damping are large contributors. In order to accurately track an input waveform, the moving assembly of a speaker must experience a restoring force linearly proportional to its displacement from center and independent of all other variables including both velocity and temperature, yet not be retarded in its motion by non-electrical damping forces. The majority of restoring force in a loudspeaker is typically supplied by one or more suspension elements. The constant of proportionality between the displacement and the restorative force experienced by those parts is called the Hook spring constant, usually represented by the parameter K or Kms (“K moving system”), or their inverse, compliance Cms (=1/Kms). In other words, the restoring force created by an ideal spring follows the equation F=X*Kms=X/Cms where X is the displacement from rest position and the value of Kms (and thus Cms) remains constant, i.e. for all values of X. This relationship and its components F, Kms, Cms, and displacement can be broken down into Cartesian components: for the spring constant, Kms_x, Kms_y, Kms_z; or into radial components: Kms_z for axial displacements, Kms_r for radial displacements; the latter generally being most applicable to loudspeaker suspensions. For an ideal loudspeaker suspension, Kms_z remains constant throughout the operational range of the loudspeaker, i.e. for all displacements Z. Deviations from this linear relationship create distortions by altering the shape of the waveform from that of the input, and the magnitude of such deviations typically increases with increasing excursion, i.e. operation at higher volumes and/or lower frequencies. In addition, a large value of Kms_r is generally required to prevent radial displacement, maintain stability of the moving parts, and prevent interference between them and stationary parts of the loudspeaker. Given that Kms_r does not need to remain linear throughout travel and, thus, Kms_r is of minor importance in determining fidelity of the waveform under reproduction, future reference to Kms and related parameters will generally refer to their axial components.

Deviations in the value of Kms from its rest, i.e. static, value take numerous forms. The first is position-dependent deviation from a constant value, wherein the value of Kms for a suspension does not remain fixed and depends on its displacement from rest position. Suspensions of the prior art typically exhibit values of Kms that depend on displacement in quadratic or quartic manner, increasing (stiffening) significantly away from center, as shown in FIG. 7 [Kms curve]. This serves to flatten the tops of the reproduced waveform, leading to distortion. Given that the mass of the moving assembly remains fixed (=Mms), the resonant frequency of the system is completely determined by the spring constant of the suspension as F=1/(2*pi*sqrt(Mms/Kms)). Thus, the effective resonant frequency of the system varies with changes in the suspension stiffness. As the resonant frequency of a system determines many of its operational attributes, the operation of a loudspeaker with such a suspension can be seen to vary dynamically with position as the suspension stiffness varies during the course of movement. It is thus desirable to have a suspension that maintains a constant value of Kms over the usable excursion of the unit, but this has been difficult to achieve using the prior art.

The inconstancy of a loudspeaker's suspension compliance also effectively limits the usable maximum loudness and/or low-frequency extension of the unit by limiting the excursion of its moving assembly. In units with suspending elements of the prior art, as the loudspeaker moving assembly moves farther from center, the restoring force increases more rapidly than is ideal, and at some point becomes too high to allow further useful movement. This creates a limit to useful excursion attainable from the loudspeaker, and is often characterized by the parameter Xsus, the excursion X at which the suspension stiffness Kms has increased by a certain amount. Numerous standards exist, a common one being an increase in Kms of a factor of 4. Reproduction of a given frequency at a higher volume requires a higher excursion of the moving assembly, while reproduction of lower frequencies at constant volume also requires larger excursions, this time in proportion to the inverse square of the frequency. Thus, loudness and/or low-frequency reproduction is limited by the maximum useful excursion of the moving assembly. A suspension capable of larger effective excursion is therefore desirable in order to maximize output level, low-frequency extension, and lack of distortion, but this also has been difficult to achieve using the prior art.

Hysteresis in the suspension Kms (i.e. dependence of Kms on velocity and prior position) is another contributor to loudspeaker distortion that is more subtle and less appreciated, despite its being readily apparent in suspensions of the prior art. The hysteresis is manifested as material “memory” and/or loss of energy therein. In other words, the Kms and thus restoring force depends not only on the position of the moving assembly, but also on the preceding history of the suspension, i.e. its prior position and how quickly it reached its current position. The polymeric materials typically used in suspensions of the prior art suffer from significant hysteresis, degrading the performance of devices built around them. In addition, these materials exhibit significant “creep”, slow deformation under force, either signal- or gravity-induced. In fact, when mounted in certain orientations, suspensions of the prior art can take on significant offsets from their original center position, degrading performance. A suspension free of hysteresis and creep is desirable for low-distortion performance, but this has not been achieved by suspensions of the prior art.

Counterposed to the restoring force of the suspension is its mechanical damping of the system, which retards the motion of the moving assembly. This type of damping is generally undesirable, as it removes energy from the system and alters the system's resonance and its waveforms. The polymeric materials typically used by suspensions of the prior art have an appreciable level of damping that also changes with position, leading to measurable distortions in the reproduced waveform. Thus, a suspension with low inherent damping and low energy loss is desirable to reduce distortion of the reproduced waveform, but this also has been difficult to achieve using the prior art.

Thus, summarizing the above, suspensions of the prior art suffer from irregularities, variabilities, and non-linearities in a value of Kms that depends on position, history, velocity, age, and temperature. As operation of a loudspeaker necessarily involves changes in all of these during normal operation, these deviations from ideal behavior lead to measurable and audible distortions in the reproduced waveform, which no longer accurately reflects the input. It is among the goals of the current invention to improve upon the prior art in the above-listed areas.

The prior art also suffers from the methods used to convey electrical current to the moving voice coil. This is typically achieved using a flexible wire from the coil to a fixed attachment point on the frame of the loudspeaker, as shown in FIG. 2. To allow excursion of the moving assembly away from its rest position, this wire must of necessity be at least as long as the farthest displacement of the assembly would require; otherwise it would restrict the motion of the moving assembly. However, at rest position, this wire is of necessity longer than the distance from attachment point to coil and thus it goes slack, bends, and extends away from the straight-line path between the two endpoints. During oscillatory motion of the loudspeaker, this can easily lead to the wire moving excessively and flapping uncontrollably, even coming into contact with other parts, leading to spurious tapping sounds and even to undesired shorting of the terminals, either through direct contact or contact with a conductive part of the loudspeaker.

A number of inventions have attempted to address these issues inherent in feeding current to the voice coil in two different ways. The first is by weaving the conducting wires into polymer- and/or fiber-based suspension elements of the prior art, but this creates other issues such as increased fatigue failure at bend points and escalated manufacturing complexity and costs. The second method is to use a suspension element with a surface layer of conductive material on top of a non-conductive base. In suspensions of this prior art, the non-conductive base, woven, polymeric, or otherwise, is largely responsible for generating the restoring force, while the secondary, conductive material carries the driving current to the voice coil. The base material is specified as non-metallic to avoid strain- and fatigue-induced failure. Thus, suspensions of this type of prior art are necessarily hybrid materials, with unequal coefficients of thermal expansion, Young's modulus, and Poisson's ratio. The differential strain can lead to delamination or even breakage of either material. Even if the material is able to withstand the rigors of operation, the base material is inherently nonlinear and lossy, exhibiting all the aforementioned negative qualities of the prior art.

Whereas prior attempts to mitigate the aforementioned deviations from ideal behavior have focused on scaling existing designs to larger sizes, using the same materials in different ways, and/or creating composite materials to improve the performance of prior designs, the inventors have discovered that by using metallic materials shaped to keep stress below the elastic limit of the material at the excursions required for operation, and/or combining the roles of restoring force and conduction in the same material using conductive materials shaped to keep stress below the elastic limit of the material at the excursions required for operation, performance of the suspension can be significantly improved and such distortions minimized. By using multiple curves and arms between them, the invention distributes the strain over a large area, thereby reducing local strain for a given total displacement, which keeps the maximum strain below the elastic limit and drastically increases linearity of motion while providing a large range of motion. This in turn allows use of materials that exhibit far less nonlinearity, hysteresis, and damping, leading to further improvements in waveform reproduction. An added and intentional benefit is that such suspensions are easy and inexpensive to manufacture, and that reproducibility is enhanced over units of the prior art.

References known to the inventor include:

U.S. Pat. No. 4,239,090, granted to Dahlquist on Dec. 16, 1980, which discloses a high accuracy bass reproducer device, including the use of a sliding element at the edge of the transducer membrane to generate a seal but no inherent restoring force.

U.S. Pat. No. 1,907,687, granted to van Lis on May 9, 1933, discloses a suspension element made of multiple non-conducting suspension arms with a conducting layer on one or both sides thereof.

U.S. Pat. No. 2,147,605, granted to Lissauer on Feb. 14, 1939, discloses suspension arms oriented in a radial direction.

U.S. Pat. No. 2,661,412, granted to Dreyfus on Dec. 1, 1953, discloses a two-state electrical switching relay employing conductive suspension elements with multiple bends, with a plurality of such parallel lamellar springs arranged radially.

U.S. Pat. No. 2,812,825, granted to Matthews on Nov. 12, 195, discloses a thermoplastic-impregnated fabric pressed suspension element.

U.S. Pat. No. 3,014,996, granted to Swanson Dec. 26, 1961, discloses a fabric suspension element with woven-in or painted-on electrical leads.

U.S. Pat. No. 5,790,682, granted to Hachiya Aug. 4, 1998, discloses a plastic “butterfly” damper element with thickened outer periphery for better attachment.

U.S. Pat. No. 5,850,462, granted to Sakamoto on Dec. 15, 1998, discloses a fabric suspension element with woven-in electrical leads.

U.S. Pat. No. 6,069,965, granted to Takewa on May 30, 2000, discloses a square suspension utilizing domed bands or strips of polymer.

U.S. Pat. No. 6,144,753, granted to Ohyaba on Nov. 7, 2000, discloses a suspension element comprising multiple arms made from injection-molded resin.

### SUMMARY OF THE INVENTION

With the above-noted prior art in mind, it is a goal of the present invention to provide an electromechanical transducer capable of producing a more linear response over a larger excursion and wider bandwidth with lower distortion, comprising an acoustic radiating diaphragm attached to two or more suspension arms made largely of electrically-conductive material that distributes strain over a large area and reduces areas of maximum stress below the elastic limit of the material, wherein a significant fraction of the restoring force generated by the suspension element is due to strain of the conductive material there incorporated. The moving assembly is mounted to a supporting frame and driven by an electromechanical transducer, either with or without an additional element mounted or sealed to the frame to reduce or eliminate air leaks and/or to provide additional restorative forces.

It is another goal of the present invention to provide an electromechanical transducer, wherein the suspending element is capable of conducting current to the mobile element.

It is another goal of the present invention to provide an electromechanical transducer, wherein the suspending element is used to conduct current to the mobile element.

It is another goal of the present invention to provide an electro-mechanical transducer, wherein the suspending element is comprised entirely of conductive material.

It is another goal of the present invention to provide an electro-mechanical transducer, wherein the suspending element is shaped to distribute strain over a large area and reduce maximum stress, thereby allowing significant displacements without mechanical failure.

### BRIEF DESCRIPTION OF THE DRAWINGS

FIG. 1 is a cross-sectional view of a typical loudspeaker incorporating the present invention.

FIG. 2 is a cross-sectional view of a typical loudspeaker of the prior art.

FIG. 3 is a cross-sectional view of the typical loudspeaker of the prior art showing the moving assembly overlaid at three positions.

FIG. 4 is a drawing of a suspension element typical of the prior art, with top and side views.

FIG. 5 is a drawing of a suspension element of the prior art with current-carrying conductors woven into the fabric, with top and side views.

FIG. 6 is a cross-sectional view of a loudspeaker of the present invention showing the moving assembly overlaid at three positions.

FIG. 7 is a graphical representation showing the restoring force on the moving assembly versus its position for a suspension created with the current invention (28), overlaid on that of the prior art (26).

FIGS. 8-19 are drawings of numerous but not exhaustive examples of suspensions created according to the new invention, in an order roughly corresponding to increasing complexity, symmetry, linearity, and performance.

FIGS. 20a and 20b are drawings of a suspension of the present invention including a non-conductive coating.

FIGS. 21a and 21b are drawings of a suspension of the present invention built up of multiple layers of material.

### BEST MODE FOR CARRYING OUT THE INVENTION

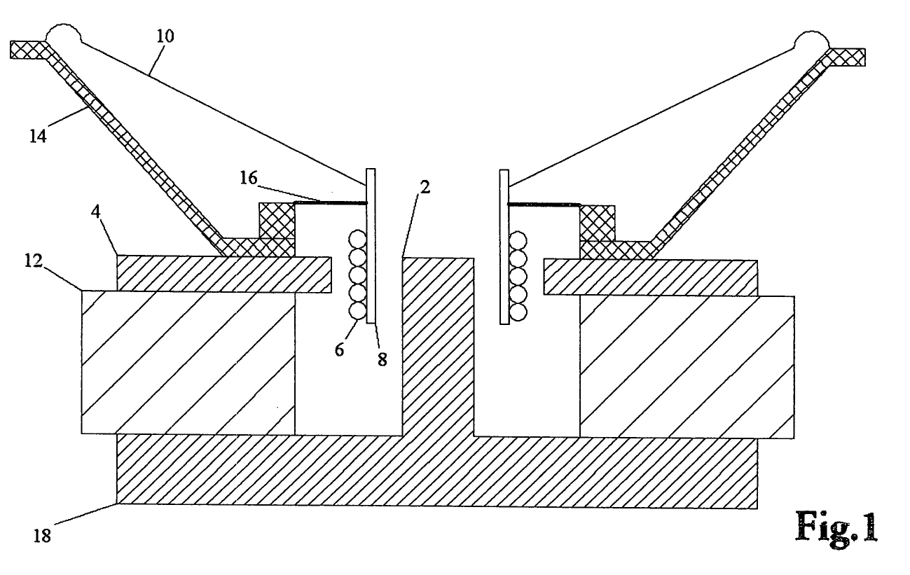

As seen in FIG. 1, the present invention is shown in a simplified drawing that shows the core of the speaker 2, a top plate 4, a coil 6, the coil former 8, diaphragm 10, magnet 12, frame 14, and backplate 18. The invention comprises placing a multi-spoke conductive suspending element 16 between frame 14 and diaphragm 10 and/or coil form 8 such that it creates a restoring force whenever the diaphragm and attached parts are displaced from rest position, that force remaining linearly proportional to the displacement magnitude to a significant degree due to the nature of the material and the shape of the suspending element keeping stress in that material below its elastic limit for significant displacements and less, thereby producing sounds with less distortion. Further advantages are in the ability to use a suspension element smaller in size yet allowing larger displacements than that of the prior art, in use of the conductive material of the suspending element to conduct current to the voice coil without need for additional wires, and in the ease of production and increased unit-to-unit reproducibility over the prior art.

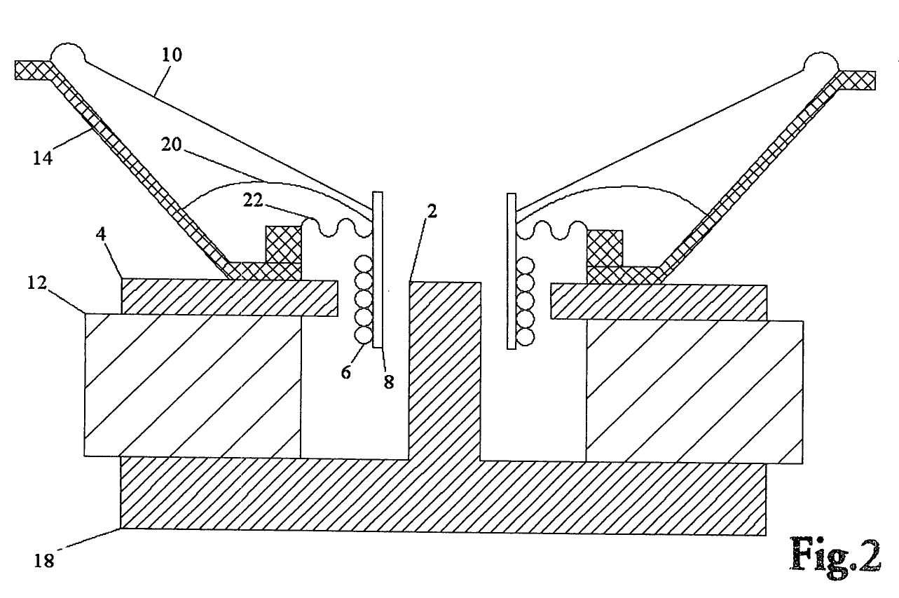

FIG. 2 shows a loudspeaker of the prior art, similar to FIG. 1 but having separate electrical leads 20 for carrying current to the voice coil and a corrugated-cloth suspension element 22 in place of the conductive suspension element 16 of the present invention.

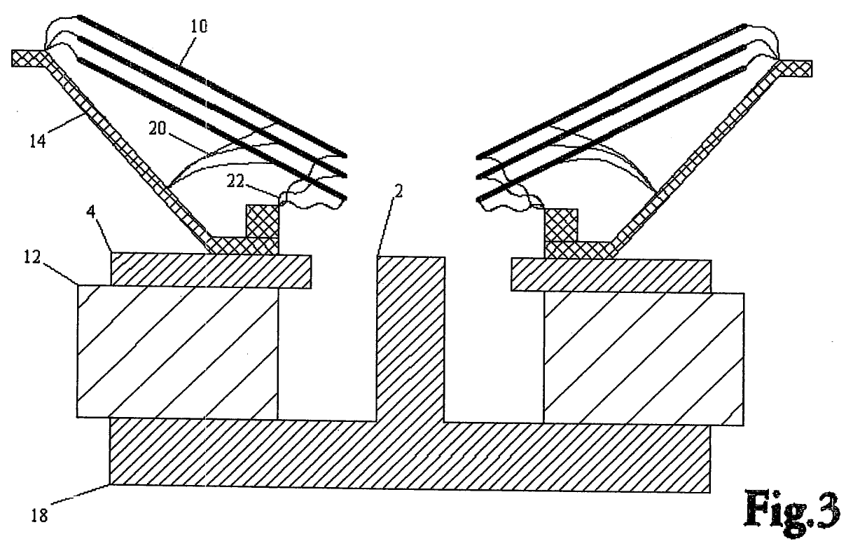

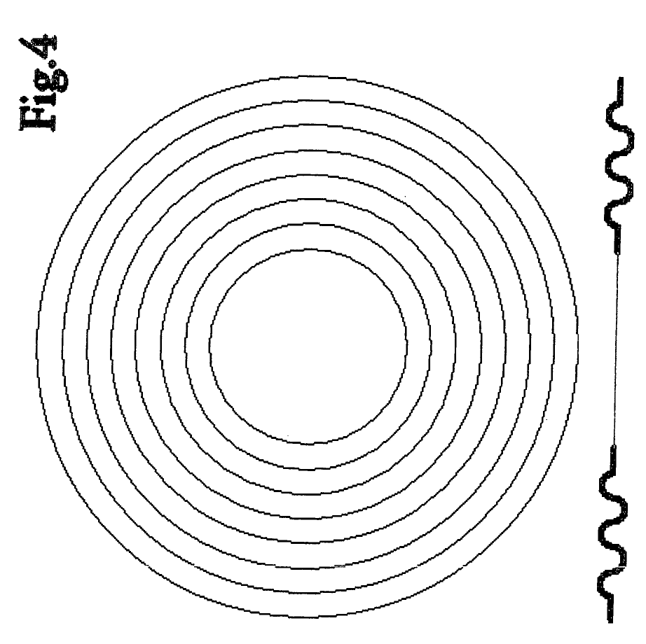

FIG. 3 shows the loudspeaker of FIG. 2 in three overlaid in three positions, at center and at large excursions both inward and outward (elements 6 and 8 are removed for clarity).

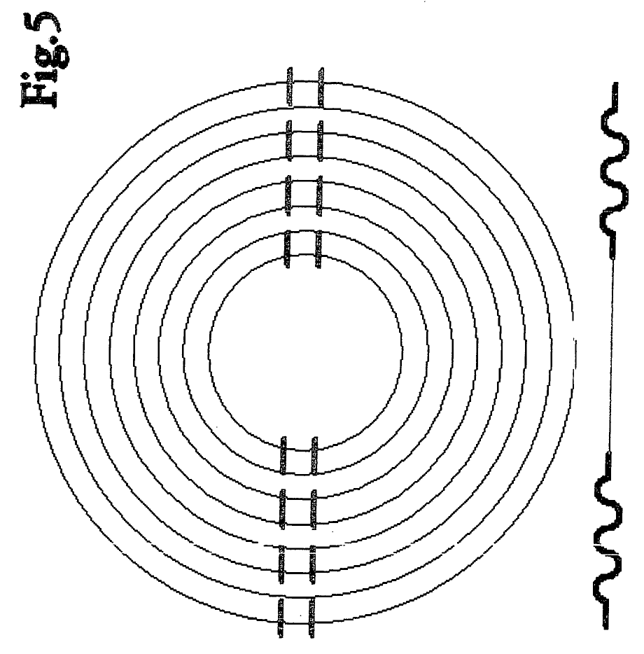

FIG. 4 shows a suspension element typical of the prior art. The most common embodiment comprises a fabric disc impregnated with one or more polymeric compounds and molded to create a corrugated shape that unfolds progressively as the suspended elements move father from the rest position. It is the lossy and non-linear qualities of the impregnating materials combined with the changing nature of the unfolding structure that leads to imperfect proportionality, hysteresis, creep, and losses in the restoring force generated by displacement.

FIG. 5 shows a conductive suspension element of the prior art in which a fabric disc incorporates conductive elements woven into the surrounding fabric for purposes of conducting current to the voice coil.

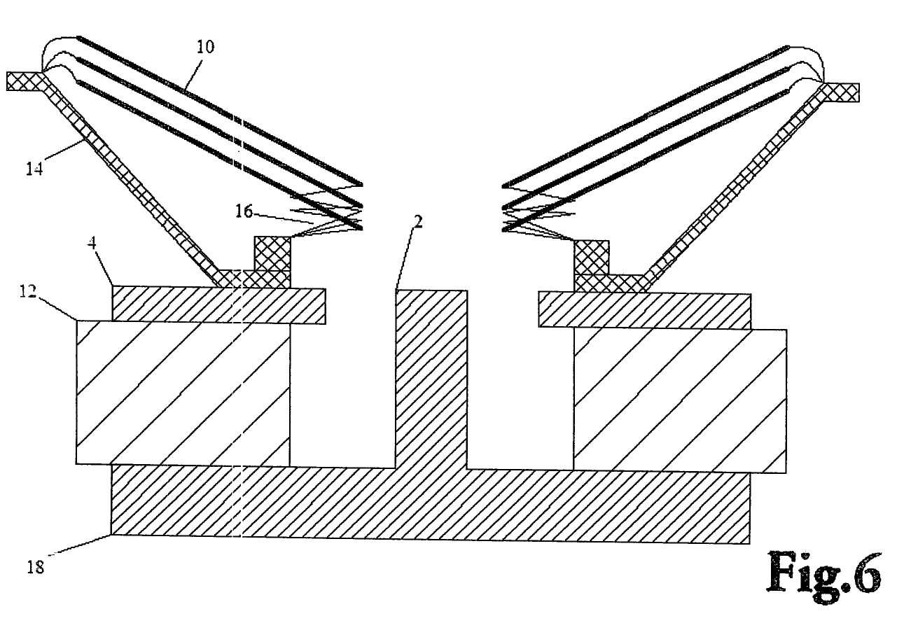

FIG. 6 displays a cross-section of a loudspeaker incorporating the present invention overlaid in three positions, at center and at large excursions both inward and outward (elements 6 and 8 are removed for clarity).

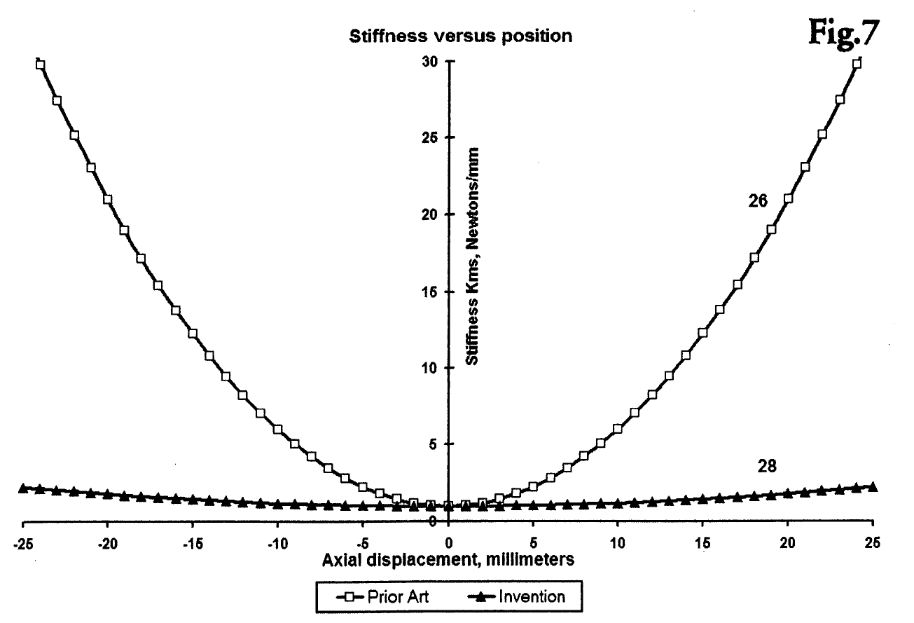

FIG. 7 displays the improved performance of the invention relative to the prior art, plotting the spring constant for similarly-sized suspensions of both types versus their displacements from rest position. The tested suspensions both have an outer diameter of 6.5′, a common size for mid-sized woofers that whose performance is often limited by the capabilities of suspensions of this size. While the plotted Kms of an ideal suspension element would remain perfectly horizontal and thus unchanging versus displacement, the suspension of the prior art can be seen to deviate significantly from ideal behavior at only modest displacements. In contrast, the invention is seen to behave almost ideally over the same range of motion, and even for significantly larger distortions.

The invention addresses the various distortions and non-ideal behavior described above by shaping the suspending element to allow use of materials with properties more suitable to the task. These are metallic and/or conductive materials that exhibit low work hardening and fatigue. Of particular suitability are hard metal alloys such as beryllium-copper, nickel-copper, stainless steel, spring steel, most tungsten alloys, amorphous or so-called “liquid” metals, and other alloys like them, and any materials, currently identified or not, suitable for standard springs. These materials are more linear, and have lower hysteresis, creep, and losses compared to polymeric materials. Laminations of the above-mentioned materials allow further tailoring of the suspension characteristics, in particular the compliance, conductivity, longevity, and resonances.

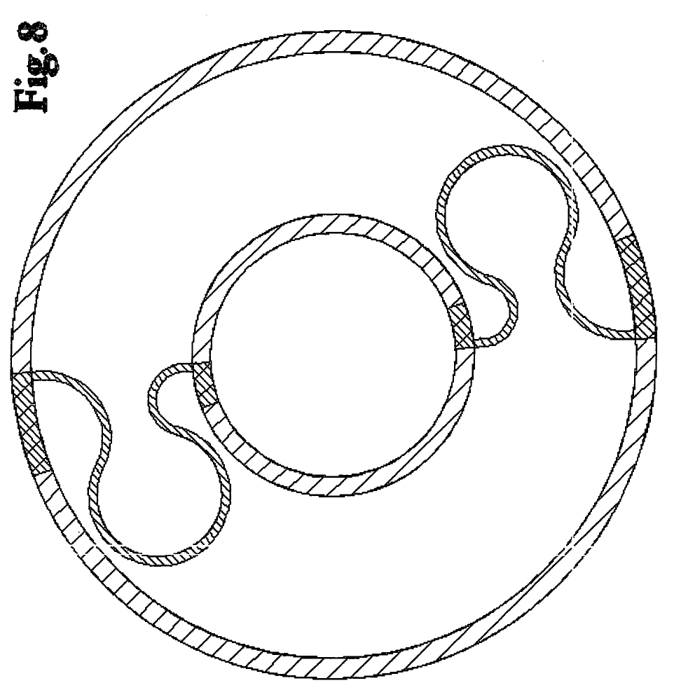

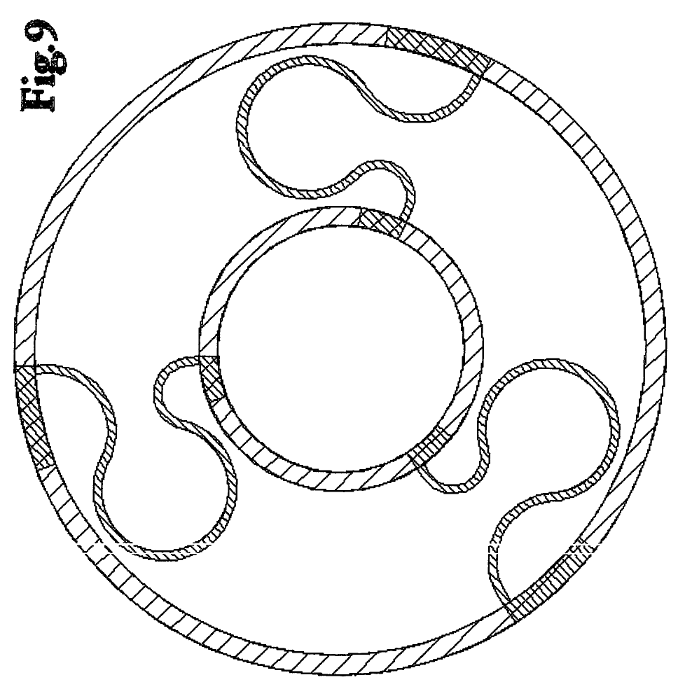

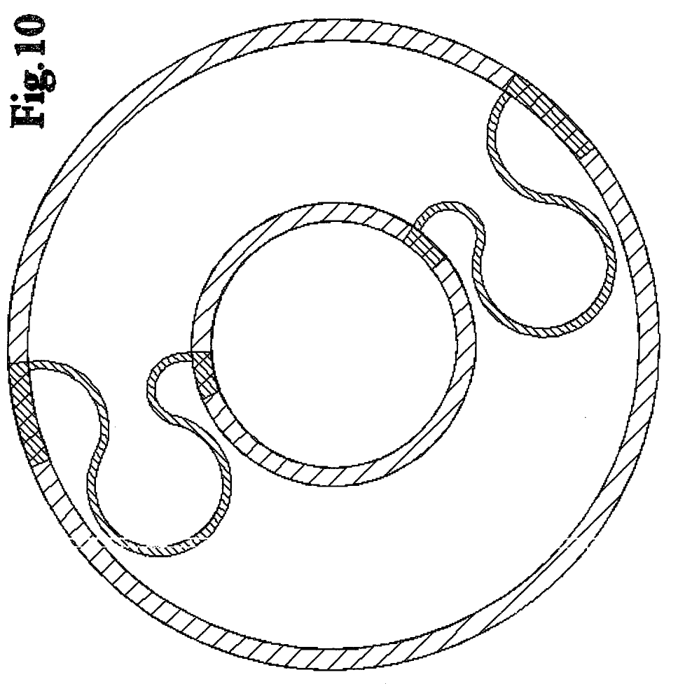

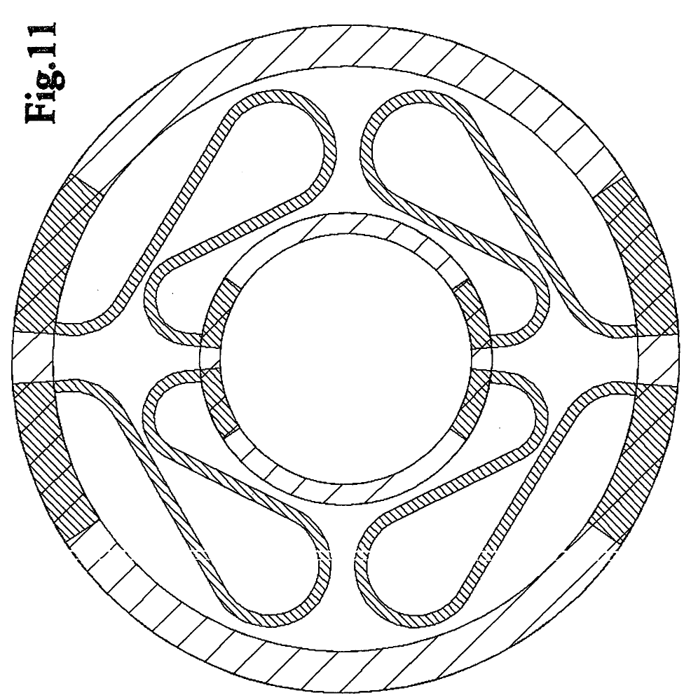

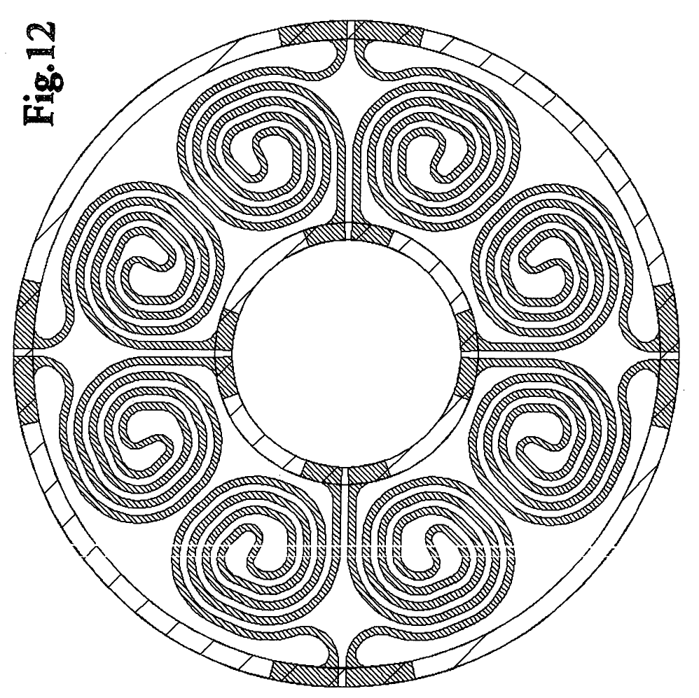

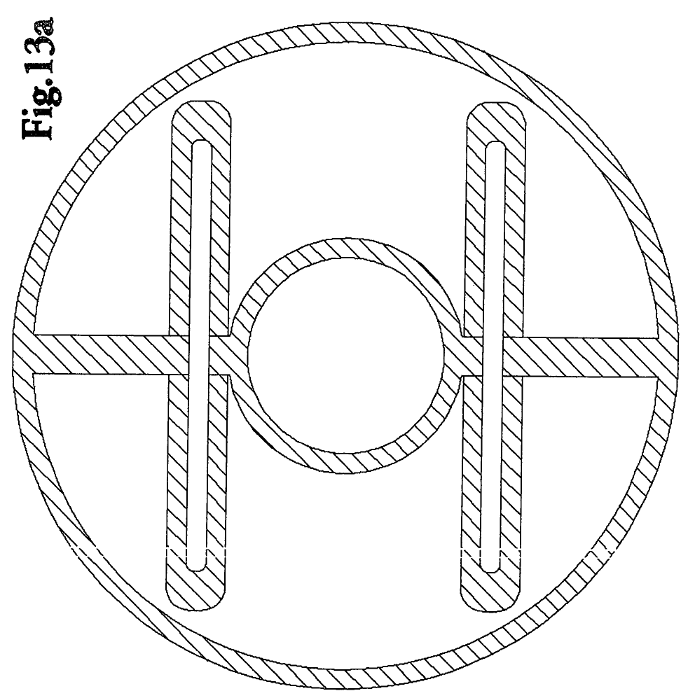

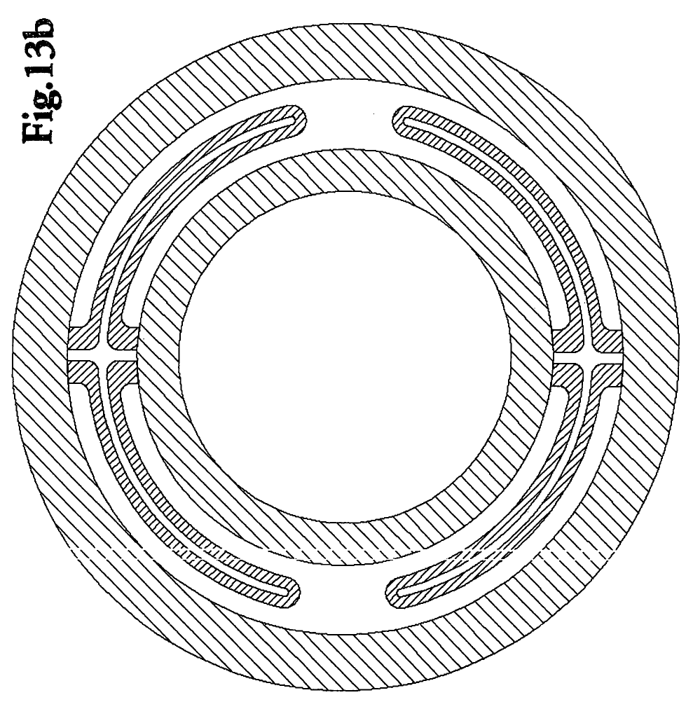

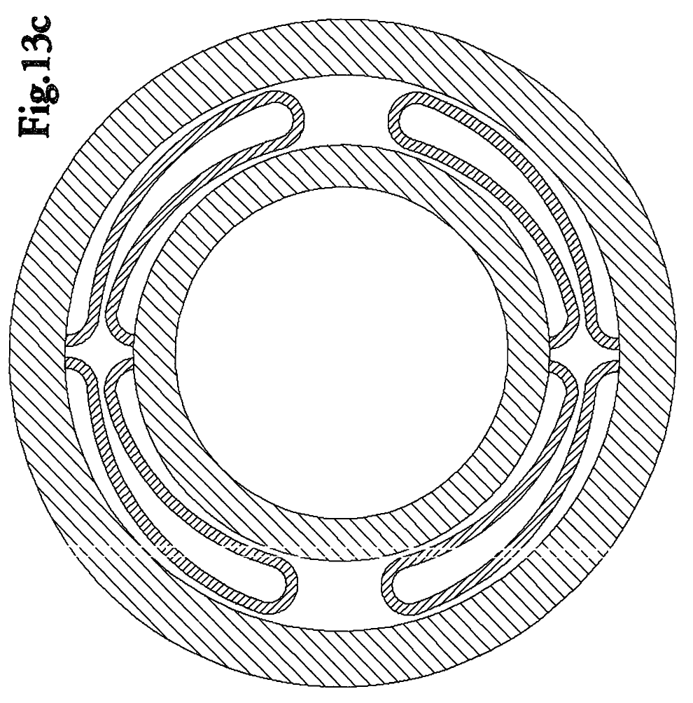

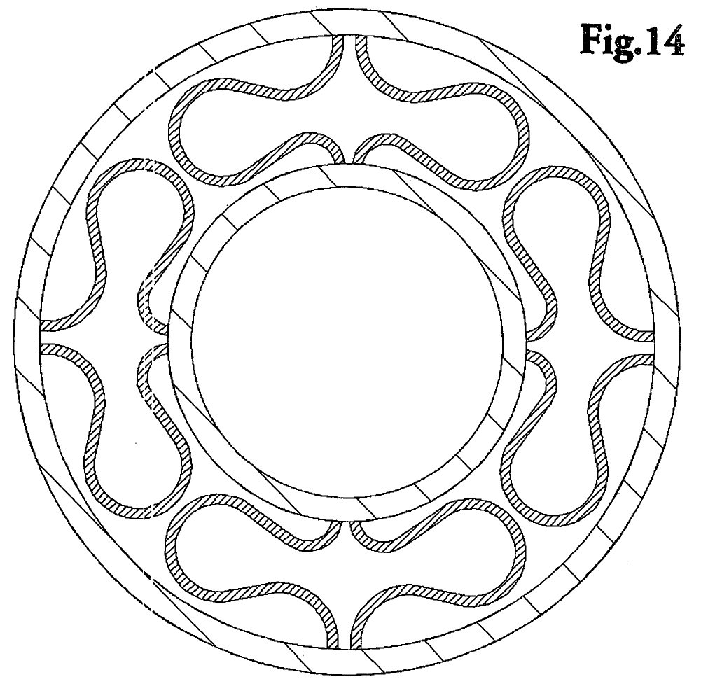

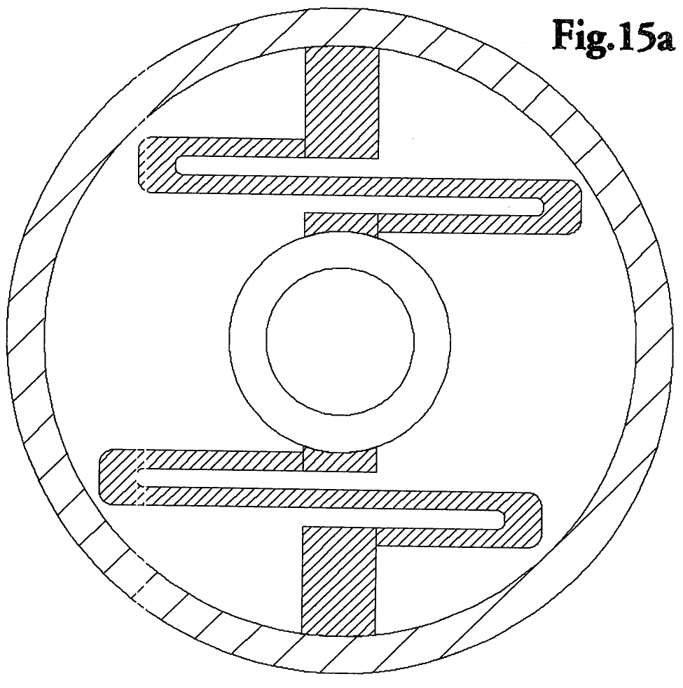

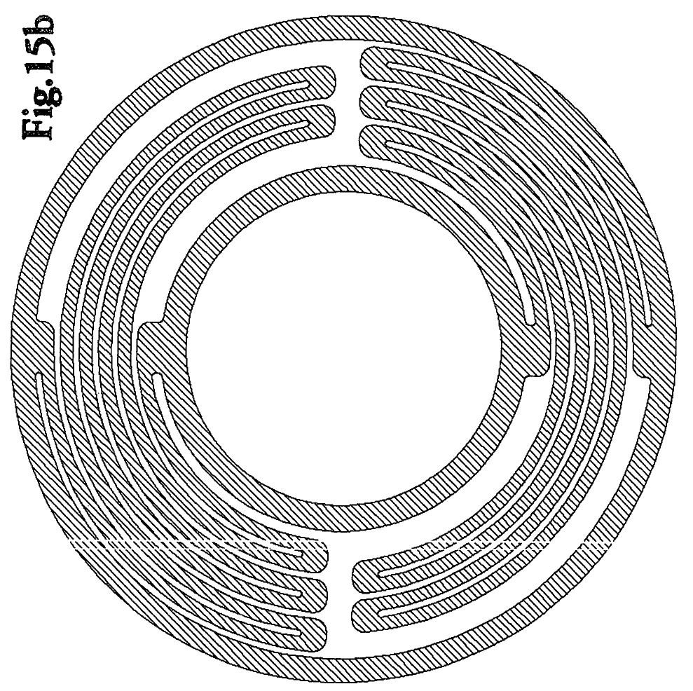

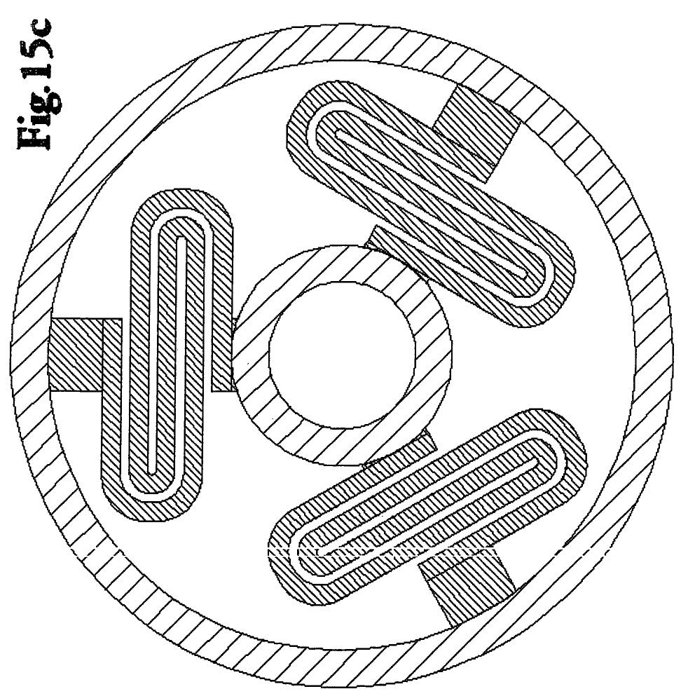

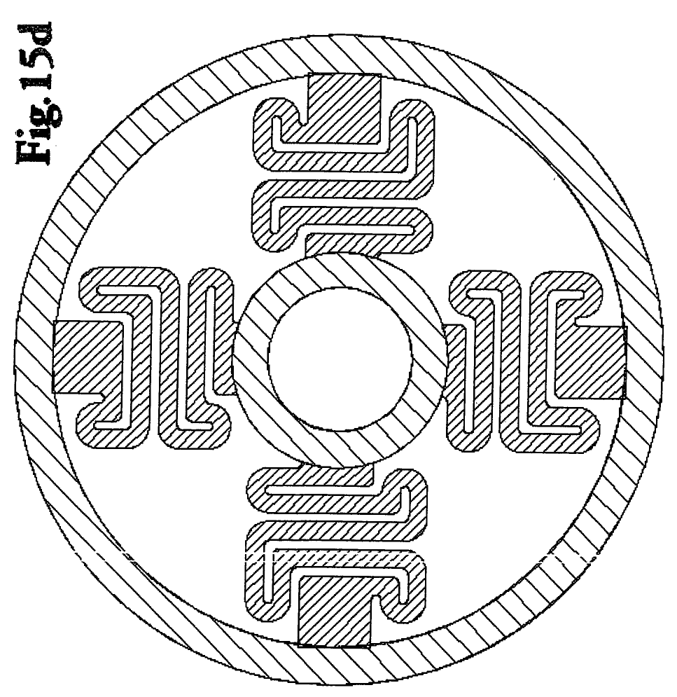

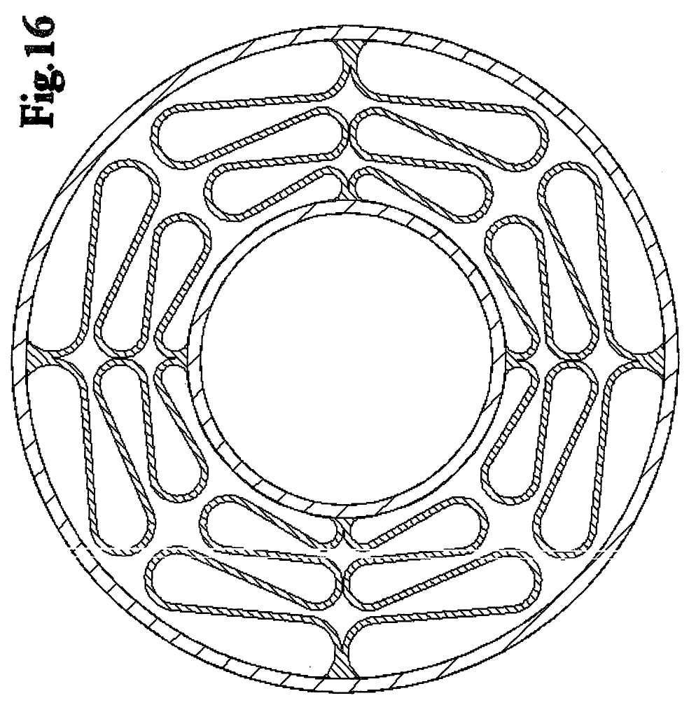

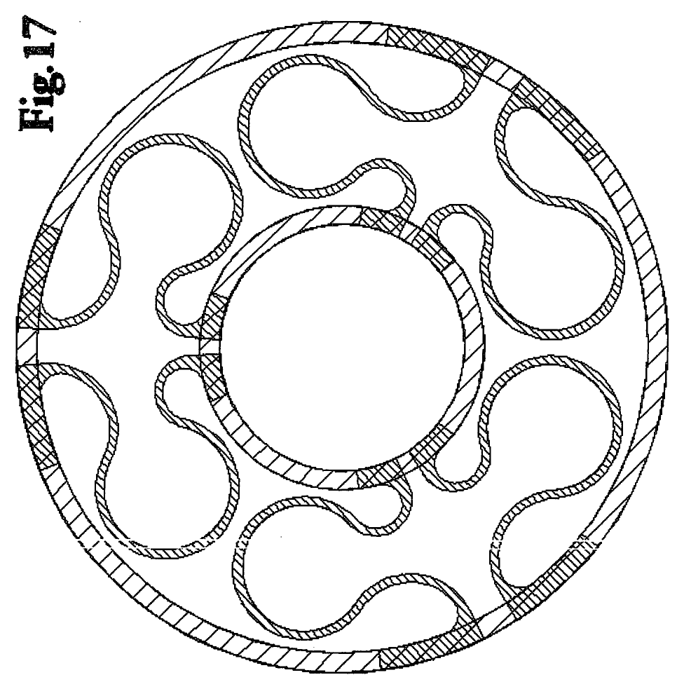

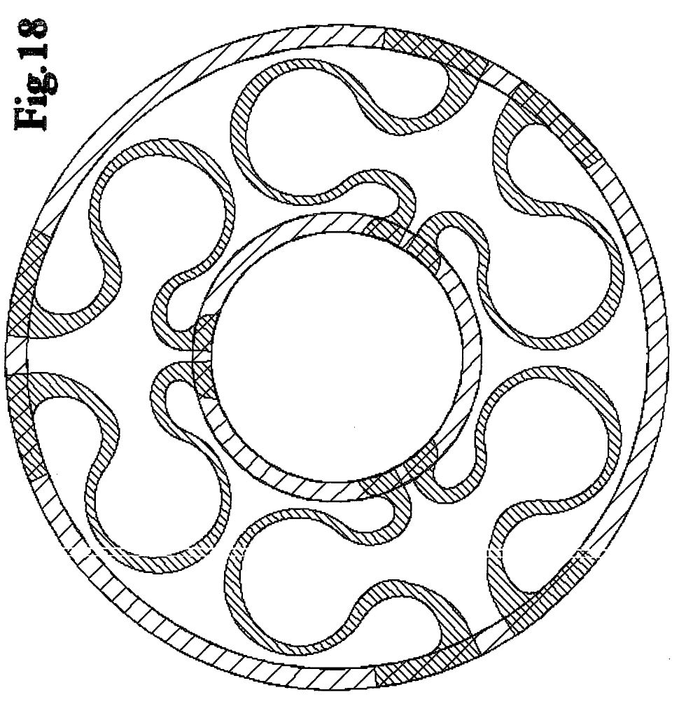

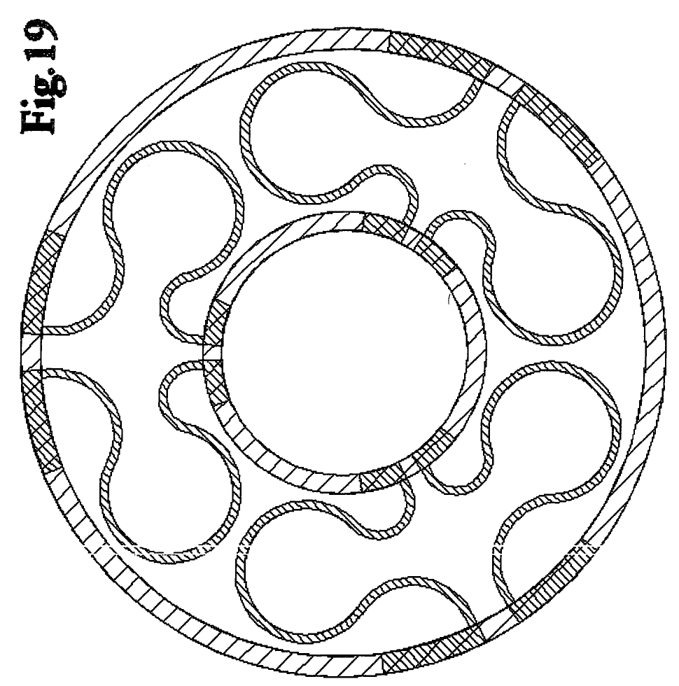

FIGS. 8 through 19 show suspensions with various though not all incarnations of the invention in an order roughly corresponding to increasing complexity, symmetry, linearity, and performance. Beginning with FIG. 8, the suspension is divided into multiple “arms”, typically though not always an even number and typically twice the number of individual coils wrapped on the former; the minimum as required for use in transmission of the number of given signal currents to and from the coils. By having the inner and outer ends of each arm be radially aligned, torque forces when axially displaced are greatly reduced; this has been a failing in the prior art. The arms are generally sinuous in shape, deviating to one or both sides of the straight radial path connecting the above-mentioned endpoints, generally in the plane normal to the axial motion, to make the arms long in path length relative to the distance between inner and outer mount points, this shape and extended length distributing stresses over a large area as mostly shear and/or torsional stresses. The sinuous paths should not be joined to each other in such a way as to restrict in-plane translation of the sinuous bends, as this allows the larger deformations of the current invention; this also has been a failing in the prior art. The arms are preferably wider in the plane normal to the axial motion than thick along that axis, to maximize Kms_r for keeping the assembly centered without undue effect on Kms_z. By using multiple identical arms with rotational (FIG. 9), mirror-image symmetry (FIG. 10), and ideally both (FIG. 11), remaining torque forces are largely cancelled; this is yet another failing in the prior art. Shapes that work particularly well tend to appear like standard types of springs (e.g. coil, leaf, hairpin, sigmoid, etc., and multiples thereof; FIGS. 12, 13, 14, 15, & 16) that have been flattened into, or nearly into, two dimensions, then skewed sideways in-plane and rerouted to avoid self-interference during axial motion both fore and aft. In addition, it is advantageous to reduce regions of high curvature (i.e. maximize arc radii and distribute curvature over maximal area), as these are areas where stress concentrates. Likewise, the attachment points where the arms mount to the frame and mobile element should be filleted to avoid stress concentrations (FIG. 17). Sharp corners are also generally to be avoided, particularly concave ones, while continuity of line/curve to the highest mathematical derivative possible is preferred where possible, ideally full second-derivative (G2) continuity or better. The arms can have a constant thickness and width, though it is desirable to taper them (width or thickness) towards the center of each arm sub-segment and/or inflection point between arcs (FIG. 18) to further distribute stress away from where it concentrates in constant-cross-section designs. In other words, increasing local width and/or thickness in areas of high local stress to reduce that stress by distributing it elsewhere, and/or decreasing local width and/or thickness in areas of low local stress to increase that stress by absorbing it from elsewhere, until all areas are stressed at approximately the same average nominal stress level. While two arms work acceptably and have been used in working prototypes, more arms give added lateral stability. A particularly good balance is found with six total arms, arranged in three mirror-image pairs (FIG. 19); this gives lateral control in all radial directions, while having enough symmetry to cancel all torque forces. The number of arms can be increased to accommodate greater than three voice coils or distribute the stress differently, but the optimal balance is in most cases achieved with a total of six arms as stated above. Both six- and eight-arm units have worked particularly well in prototypes. The system is readily modeled by common finite element and standard mathematical methods to determine the optimum for the given conditions and materials, and to find areas of above-average stress that require thickening and/or widening to distribute stress away therefrom.

Given a successful design, it can be adapted to use in other devices requiring increased values of Kms by thickening the material by a factor of approximately the cube root of the factor of increase required, or by widening by a factor approximately equal to the factor increase required. Likewise, decreased Kms can be achieved by dividing by such factors. Both approaches can be combined for even larger changes in Kms.

In most cases, one or more additional features will be required to allow attachment of the suspension arms to both the stationary part of the overall device and to the mobile part(s) thereof. There are numerous methods, but perhaps simplest method is to incorporate part or all of a circular or other appropriately-shaped mounting ring at the inner and outer peripheries of the suspensions are, to be attached to the stationary frame, voice coil, its former, and/or the cone in the same way(s) as commonly-used suspensions of the prior art (generally corrugated fabric discs). In addition, it is possible to incorporate one or more mounting features not found on suspensions of the prior art, such as mounting tabs, flanges, collars, and/or holes for fasteners, clamps, adhesives, etc.

A suspension of this invention can be made in one or many pieces to facilitate ease and variability in manufacturing. They can be cut as one complete piece incorporating all suspension and mounting features, or as sub-sections thereof incorporating one or more suspension arms, with or without integral mounting features. For example, given a design with three pairs of mirror-image suspensions arms, this can be made as one complete piece incorporating six arms and two mounting rings one each at the inner and outer circumferences of the arms, as two identical pieces each incorporating three suspension arms and approximately one-half of a mounting ring at both the inner and outer ends of the arms, as three identical pieces each incorporating two suspension arms and one-third of each mounting ring, as six identical pieces with one suspension arm and a portion of the mounting ring each, or as simply six identical suspension arms able to be mounted to the rest of the device at their inner and outer ends. The choice among such options generally depends on the number of conductors required for carrying current to and from the mobile coils in the system, though this is not required if alternate means are used such as layering separate electrically-isolated conducting layers.

Most conventional means of manufacture can be employed to make a suspension of this invention, though some are preferred for ease, cost, or strength considerations. Sintering is possible, though the mechanical properties of thus-formed materials tend to be weaker and thus of lower performance in this role. A larger piece of material can be cut to shape by low-deformation methods such as water-jet, plasma, and laser cutting, though care must be taken not to overheat the material to the point of changing its properties. Stamping, punching, and forging are all good alternatives, and can in fact improve the elastic properties of the materials in the formed piece. Molding can be accomplished, though special care during and/or after forming is usually necessary to prevent a weakened product. One exception to the caveats on molding is in the use of amorphous materials that do not phase separate during the hot stage(s) of processing, thereby preventing the weakening caused in materials that do undergo phase separation. However, a novel method of manufacture using wire is expected to be one of the most amenable to large scale production, and is herein described. Wire of approximately the desired cross-sectional area can be formed into the desired suspension shape, and works reasonably well in this form. However, additional performance can be obtained by taking such a formed wire piece of and pressing it to a desired thinner dimension along the direction of axial travel, increasing the width and thereby the Kms_r. Such a wire can be pressed into a mold, allowing for more exact dimensioning while maintaining the properties of the material. The thickness of such a piece can also be varied along the arm path length by a mold of differing depths to effect the desired distribution of stresses. This latter approach takes advantage of the differential dependence of stiffness on width (normal to axial motion) versus thickness (parallel to axial motion); stiffness increases approximately linearly with width, but increases as the cube of the thickness, thus allowing subtle tailoring of local stiffness merely by adjusting the local cross-sectional shape (i.e. thickness versus width) while still maintaining the same cross-sectional area of the original wire from which it is formed.

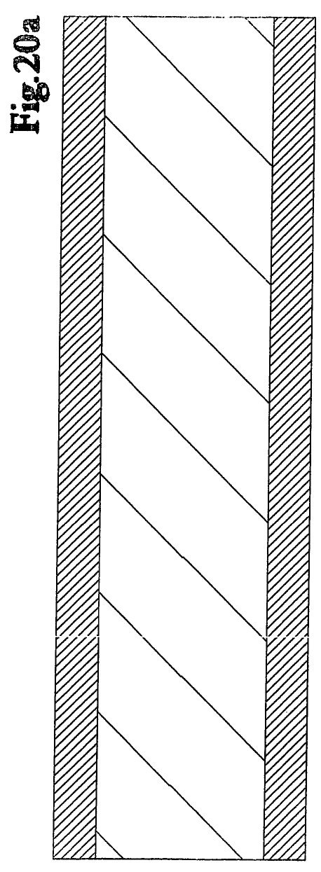

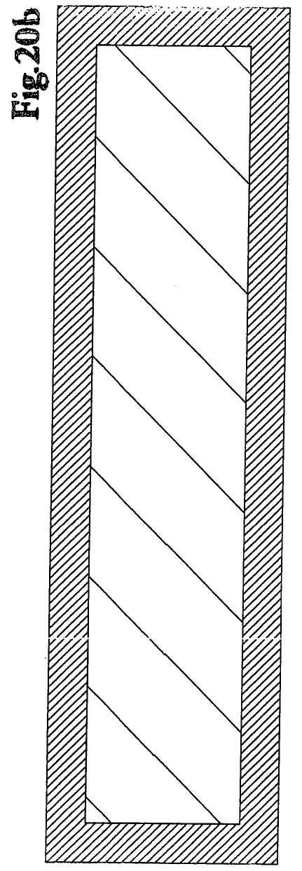

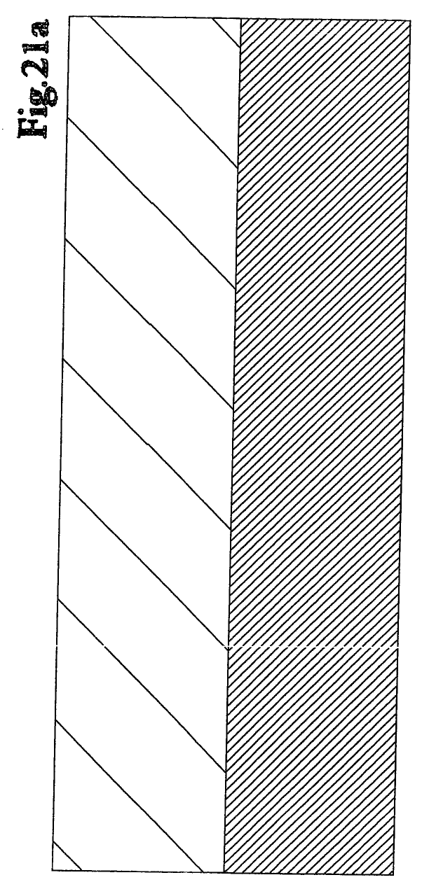

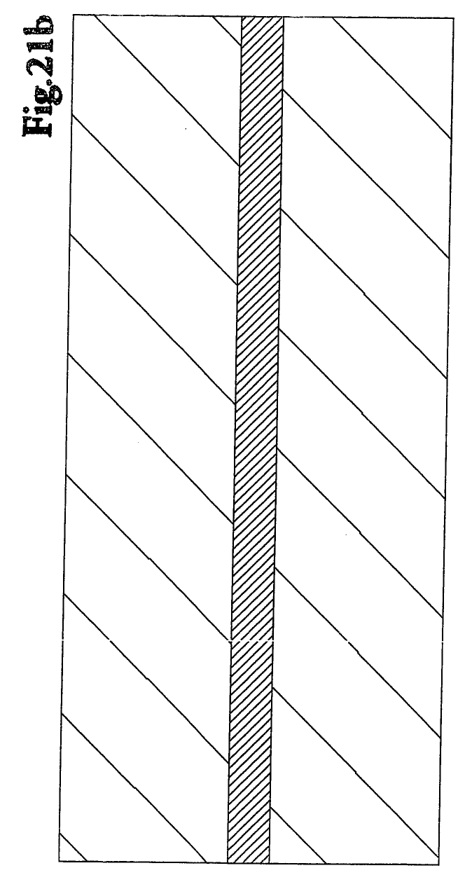

In general, the greatest linearity is obtained with the suspension arms being made almost exclusively of metal, but in some cases it will become necessary to incorporate insulating and/or lossy materials to prevent other problems while still deriving a majority of the stiffness from the metallic component (FIG. 20). It is often necessary to apply a coating to provide electrical insulation of the arm, where a thin, pliable, and low-loss material is usually favored. The suspension arms have resonance modes of their own, of magnitude depending on the dimensions, shape, and material, and it may be necessary to damp such resonances by applying a damping compound to one or more of their surfaces; a lossy polymeric material is generally preferred. Insulating and damping functions can often be combined in the same added material, as most damping compounds are also electrical insulators. Such materials can also be incorporated between multiple layers of metal, constraining the damping layer and often allowing each layer to function as a separate conductor (FIG. 21). Layering of more than one metal can also help ameliorate such resonances without greatly increasing the overall damping of the system. Keeping the path length of each arm to a minimum required for the desired performance will minimize the number and severity of resonant modes, as can minimizing the unsupported span in each arm sub-section. In all cases it is desirable to have a majority of the stiffness created by the metallic component and not the other materials.

However, the circular nature of the example and the position of its parts are only one of many arrangements that will produce the stated benefits; the benefits derive from the use of conductive and linear materials in shapes that distribute the strain to reduce stress and allow those materials to be used without exceeding their physical limits. The benefits are independent of the arrangement of the other parts of the loudspeaker, and can thus be combined with other art. The electromotive force, though depicted as a current-carrying voice coil in a magnetic field, is understood to be any electromotive force that can excite the moving assembly. It is not limited to round shapes, nor number of arms.

This invention has utility when applied to all sizes and types of linear electromotive actuators, both audio and non-audio. This includes the full range of audio transduction devices: tweeter, midrange, woofer, headphone, microphone, etc., though it provides greatest benefit for those devices with large excursions and/or requiring low losses and/or low hysteresis. It is also applicable to non-standard audio transducers, such as those without traditional cylindrical coils or conical diaphragms (e.g. U.S. Pat. No. 4,903,308). Possible non-audio applications include but are not limited to linear actuators and hard-drive recording head actuators.

Although the mode described above for carrying out the invention relates one structure in detail, it will be understood by those skilled in the art that various changes, substitutions, alterations, and combinations with other art can be made therein without departing from the general spirit and scope of the invention as defined by the following claims and embodied by the preceding descriptions.

1. A suspension element allowing motion fore and aft along a single axis and comprised of:
a discontinuous plate wherein there are 2 or more compliant suspension arms, each arm having its outer attachment point lying largely along the same radial line as the inner attachment point, each arm with a central portion deviating circumferentially to at least one side of the aforementioned radial line, with one or more arm segments, arranged such that the midportion thereof can translate along at least one of the circumferential or radial directions during axial translation, so as to distribute stress mostly in shear along and torsion across the path.

2. An apparatus of claim 1 made of metal.

3. An apparatus of claim 1 made of spring metal.

4. An apparatus of claim 1 made of amorphous metal.

5. An apparatus of claim 1 made of non-crystalline metal.

6. An apparatus of claim 1 made of a material having an electrical conductivity equal to or greater than 100 Siemens per meter.

7. An apparatus of claim 1 made of a material having an electrical conductivity equal to or greater than 100 Siemens per meter layered or coated with a material of lower or zero conductivity.

8. An apparatus of claim 1 made of a composite of metal and one or more other materials.

9. An apparatus of claim 1 having two or more arms electrically isolated from each other.

10. An apparatus of claim 1 having two or more electrically isolated layers.

11. An electro acoustic transducer employing the apparatus of claim 1 as its suspensions element.

12. An apparatus of claim 1 made of formed wire.

13. An apparatus of claim 1 made of formed and pressed wire.

14. An electro acoustic transducer comprising:
a suspending apparatus of claim 1;
a magnetic assembly producing a magnetic field;
a supporting frame;
an electrically-conductive and mobile coil member disposed in the magnetic field capable of moving axially through the magnetic field;
an acoustic-radiating diaphragm attached to and moving with the coil; and
an air seal at the edge of the diaphragm.

15. An apparatus of claim 14 wherein one or more of the suspension elements are used to conduct current to the mobile coil member.
